(19) United States
(12) Patent Application Publication
(10) Pub. No.: US 2026/0145887 A1
(43) Pub. Date: May 28, 2026

(54) TURNING STARWHEEL

(71) Applicant: Körber Pharma Inspection GmbH, Markt Schwaben (DE)

(72) Inventors: Stephan Enninger, Markt Schwaben (DE); Andreas Mayr, Markt Schwaben (DE); Hans Baumgarther, Mark Schwaben (DE)

(21) Appl. No.: 19/400,443

(22) Filed: Nov. 25, 2025

(30) Foreign Application Priority Data
Nov. 26, 2024 (DE) 10 2024 134 754.6

(51) Int. Cl. B65G 47/86; B65G 29/00

(52) U.S. Cl. CPC B65G 47/847; B65G 29/00; B65G 2201/0244; B65G 2811/0626; B65G 2811/0636

(57) ABSTRACT

A turning starwheel for turning medical containers includes a base element on which a plurality of turning elements is provided, wherein each turning element includes a holding element configured to hold and turn a medical container, a first contact element configured to come into contact with a first control cam, wherein the turning element is configured to shift relative to the base element between a first position and a second position depending on the first control cam.

### BACKGROUND OF THE INVENTION

The present disclosure relates to a turning starwheel or rotary starwheel for turning medical containers and a method for turning medical containers.

During inspection processes of medical containers, it is often necessary to turn the containers in order to be able to inspect the entire container. Furthermore, turning the medical containers can cover any fluid bubbles present in them and adhering to the inner wall of the container with the fluid. Nevertheless, a medical container containing a fluid must not be turned too quickly, as this could generate excessive air bubbles, which could later lead to problems during inspection. Due to the increased demand for medical products, it is also a goal to be able to inspect as many medical containers as possible in a short time.

Therefore, it is an object of the present disclosure to provide a device and a method in which medical containers can be turned safely, reliably, and quickly, in particular for inspection.

### SUMMARY OF THE INVENTION

According to one aspect of the present disclosure, a turning starwheel is provided for turning medical containers. The turning starwheel may comprise a base element on which a plurality of turning elements is provided. Each turning element may comprise a holding element designed to hold and turn a medical container and a first contact element designed to come into contact with a first control cam. The turning element may be designed to move relative to the base element between a first position and a second position depending on the first control cam.

Compared to the known prior art, the subject-matter of the present disclosure offers the advantage that medical containers can be turned using a compact turning starwheel. Compared to a known multi-part turning tower, the above-mentioned turning starwheel requires considerably less space. By shifting or displacing between the first position and the second position, the medical containers can be moved in such a way that adjacent containers do not collide with each other during rotation or turning. This allows a narrow pitch of at least 12 times π to be provided, which increases throughput while reducing space requirements.

The turning starwheel can be an instrument or laboratory instrument used to transport and/or handle medical containers. A turning starwheel can transport a variety of medical containers. The medical container can be transferred to the turning star at a transfer point and delivered from the turning starwheel at a delivery point. A medical container can only be transported along a section of the circumference of the turning starwheel. The turning starwheel can be designed to be essentially circular. A medical container can include a syringe, a vial, a cuvette, an injection bottle, ampoules, or other medical containers. Medical containers usually have a small volume and high hygienic standards. The medical containers comprise glass or may be made entirely of glass and may therefore be fragile. Consequently, great care must be taken when handling the medical containers. The medical containers may contain a fluid. During an inspection of the medical containers, the fluid can be examined for contamination. Furthermore, damage to the medical containers can also be detected during the inspection. The base element of the turning starwheel can form a central part of the turning starwheel. Optionally, the turning starwheel is rotatably fixed to its base element. The base element can be a circular element. The base element can be a plate-like circular element that can rotate around an axis. A plurality of turning elements can be provided on the base element. The turning elements can be movable relative to the base element. This ensures a high degree of individual handling of individual medical containers by the movable turning elements. A plurality of turning elements may be provided on the circumference of the base element. The turning elements may be fixed adjacent to each other on the base element. This makes it possible to provide a plurality of turning elements on the base element. Each turning element may have a holding element. This allows a plurality of holding elements to be arranged on the base element via the plurality of turning elements. The holding element can be designed to hold one medical container at a time. Optionally, each holding element can hold only one medical container. Holding can mean that the holding element is designed to grip and hold a medical container. Optionally, the holding element may be designed to secure a medical container during its movement. This makes it possible to move a medical container within the room. Furthermore, the holding element may be designed to turn the medical container. Turning may mean that the medical container is rotated or turned about an axis. The contact element may be part of the turning element, which is designed to come into contact with a control cam. To come into contact here may mean that the contact element comes into direct contact with the control cam. The contact element may therefore touch the control cam. This allows the contact element to follow the path of the control cam when the contact element and the control cam are moved relative to each other. The contact element can be designed in such a way that friction between the control cam and the contact element is minimized. This prevents heat generation and energy loss, enabling efficient operation of the turning starwheel. The turning element is designed to move from a first position to a second position. The movement between the first position and the second position can be determined or controlled by the control cam. In other words, the turning element can then move from the first position to the second position when the control cam contacts the contact element in such a way that the turning element is transferred to the second position. It is also conceivable that the control cam also controls a transfer from the second position back to the first position. The control cam may also be referred to as a running curve. The control cam may define a contact surface or a contour to which the contact element can come into contact, so that the contact element is moved along the control cam during a relative movement between the contact element and the control cam and is thereby positioned in space by the control cam. Thus, depending on a control cam, a turning element can be moved relative to the base element. This allows two adjacent turning elements to be moved relative to each other in such a way that medical containers attached to the turning element can be turned without contacting adjacent turning elements or medical containers. This means that the individual turning elements no longer need to be arranged so far apart along the circumference of the base element that medical containers can be turned without any problems, but can be fixed close together (for example, adjacent to each other) on the circumference of the base element, since it is possible to move each holding element from the first position to the second position before turning the medical container held thereon, so that the medical container can be turned without any problems. Optionally, the turning element is shifted from the first position to the second position in sequence for adjacent turning elements. In other words, the shift between the first position and the second position can be performed sequentially. This ensures that adjacent turning elements or the medical containers held on them do not come into contact with other turning elements or other medical containers. This allows the large number of turning elements to be arranged closer together on the base element, which can increase the throughput of medical containers.

Optionally, the base element can rotate around a first axis. The first axis can therefore essentially be orthogonal to the base element. This means that the turning elements attached to the base element can also rotate around the first axis. The circumference of the base element to which the turning elements are attached can be arranged orthogonally to the first axis.

Optionally, the plurality of turning elements is arranged on the base element. The turning elements can be detachably arranged on the base element. This allows the turning elements to be easily replaced. This facilitates maintenance and reduces downtime.

Optionally, the base element is essentially circular in shape. This allows a circumference to be defined that is equidistant from the center point at all points and thus has the same rotational speed around the center point of the base element. This ensures that each turning element also has the same rotational speed.

Optionally, the turning elements are detachably held to the base element. This allows each turning element to be easily replaced. This makes it easy to change the format of the medical containers to be transported.

Optionally, the turning element can be shifted (displaced) relative to the base element. In other words, the turning element can be moved away from or toward the base element. It is important that the turning elements are moved into a different arrangement that differs from the adjacent turning elements. This ensures that the medical container can be turned easily without coming into contact with adjacent turning elements or medical containers.

Optionally, the second position is further away from the base element than the first position. In other words, the turning element can be moved away from the base element when shifting between the first position and the second position. This creates more space by making it possible to turn the medical container. Particularly in the case of a circular base element, it is advantageous that the turning element is moved away from the base element when shifting between the first position and the second position, as this creates a larger area for turning the medical container.

Optionally, the turning element can be shifted (displaced) translationally between the first position and the second position. In other words, the turning element can be moved from the first position to the second position. Thus, there can be no rotation of the turning element between the first position and the second position. This means that the turning element is shifted between the first position and the second position along a straight line. This can simplify control by the control cam.

Optionally, the second position is further away from the base element in a radial direction than in the first position. In other words, it is preferable that, in the case of a round base element, the turning element is moved outwards in a radial direction. This allows optimal sequential shift of the turning elements on the base element to be achieved. Furthermore, control by the control cam is simplified.

Optionally, the position of the turning element relative to the base element depends on a circumferential position of the turning element along a circumference of the base element. In other words, the control cam can be fixed and the base element can rotate relative to the control cam. The turning elements are fixed to the base element so that they can rotate together with the base element. This allows the turning elements to be moved along the control cam. Since the control cam is fixed relative to the base element, the question of whether a turning element is in the first position or the second position may depend on where the turning element is located along the circumference of the base element. Thus, in an absolute coordinate system, the turning elements can always be shifted from the first position to the second position at the same location. In other words, the turning elements can always be shifted at the same location relative to the base element.

Optionally, the turning element has a second contact element that is designed to come into contact with a second control cam. The second contact element can be designed analogously to the first contact element. The second contact element can be designed to receive further control information from a second control cam. This allows a further functionality of the turning element to be controlled by a control cam. Otherwise, the second control cam provides the same basic advantages as the first control cam.

The second contact element is designed to control the rotation of the holding element. In other words, the rotation or turning of the medical container can also be controlled depending on the position of the turning element along the circumference of the base element. For example, the first control cam and the second control cam can be arranged relative to each other in such a way that the first control cam causes the turning element to be shifted between the first position and the second position in such a way that space is created for the medical container to be turned. If the turning element is in the process of being shifted between the first position and the second position or is in the second position, the second control cam can be designed so that the second contact element initiates a turn or rotation of the medical container. This makes it easy to achieve dependent control. It also ensures reliable control. This is important in order to avoid miscontrol, in which, for example, a medical container is turned even though it would come into contact with an adjacent element and thus be damaged. This offers considerable advantages over electronic control, as the dependencies of the first control cam and the second control cam ensure that the medical container is only turned when this is possible without any problems.

Optionally, the second contact element is spaced apart from the first contact element on the turning element. This ensures that the first contact element and the second contact element do not restrict each other. Furthermore, the control cams can be designed and arranged in such a way that a satisfactory contact surface between the contact element and the respective control cam is ensured. This allows independent control of the first contact element and the second contact element by the first control cam and the second control cam.

Optionally, the turning element has a return element that is designed to push the turning element into the first position. Thus, when the control cam no longer contacts the first contact element, so that the turning element is pushed into the second position, the turning element can automatically return to the first position. This ensures that the first contact element always remains in contact with the first control cam. In other words, the return element can be designed to press the contact element against the first control cam. This ensures that the first contact element always follows the contour of the first control cam. This ensures precise control of the turning element. Furthermore, it is not necessary to provide a device on the cam that ensures that the turning element returns from the second position to the first position. The return element can be, for example, a spring. Furthermore, the return element can be an elastomer element designed to exert a return force on the turning element.

Optionally, the turning element has at least one guide element that is designed to guide the turning element between the first position and the second position. This prevents the turning element from being deflected and deviating from a desired shift path between the first position and the second position. The guide element may, for example, be a guide rod along which the turning element can slide. This ensures the translational movement. Furthermore, the guide element ensures that even at high rotational speeds of the turning starwheel, optimum guidance of the turning element between the first position and the second position is guaranteed.

Optionally, the first control cam differs from the second control cam in terms of arrangement and/or shape. In other words, the first control cam can give a different control command compared to the second control cam. The first control cam can be identical in design to the second control cam and only differ in its arrangement. More precisely, the control cam may have a substantially circular outer contour, at which at least one bulge or other contour variation is provided. This allows the first contact element, which is in continuous contact with the contact surface of the first control cam, to be activated or shifted at a specific point. The second control cam can be designed identically. In this case, the second control cam can be arranged slightly offset from the first control cam. If the control cams are essentially round in design, the bulge or other contour of the second control cam can be arranged offset from the bulge or other contour of the first control cam. This allows the first contact element and the second contact element to be controlled differently. This is particularly advantageous if the first contact element is responsible for shifting the turning element, wherein the second contact element is responsible for turning or rotating the medical container held on the turning element. For example, it can be defined that the turning or rotation of the medical container only takes place when the turning element has been shifted. This allows for simple and fail-safe control.

Optionally, the first base element is designed to be movable relative to the first control cam and/or the second control cam. In other words, a relative movement between the first control cam and/or the second control cam may be possble. Optionally, the first control cam and the second control cam are fixed, whereas the base element moves relative to them, in particular rotates. Since the turning elements are fixed to the base element, the base element can move the turning elements along the control cam so that the first contact element and/or the second contact element comes into contact with an associated control cam.

Optionally, the first control cam and/or the second control cam run continuously.

In other words, the control cams can be designed so that the contact element is always in contact with the respective control cam. In other words, there can be no holes or recesses in the control cam. This offers the advantage that, in the event of wear on the contact surfaces, it is possible to easily adapt to a worn condition, whereas in the case of a recess, the new contact can cause problems every time wear occurs here.

Optionally, the first contact element and/or the second contact element has a roller element that is designed to come into contact with the first control cam and/or the second control cam. The roller element can reduce wear on the control cam or contact element, as it can reduce friction between the contact partners moving relative to each other. In this case, a rotational axis of the roller element can be parallel to the first axis around which the base element rotates. This allows the turning starwheel to be operated for longer without requiring maintenance.

Optionally, the first contact elements of two adjacent turning elements are arranged at different positions on the turning elements. The position of the contact element on the turning element can determine which cam the contact element comes into contact with. If, for example, two contact elements of adjacent turning elements are assigned to the same control cam, the two adjacent turning elements will move synchronously with each other. However, if the contact elements of two adjacent turning elements are assigned to different control cams, independent control of the two turning elements is possible. In other words, the two adjacent turning elements can be moved differently. This makes it possible, for example, to shift one turning element from the first position to the second position, while the adjacent turning elements remain in the first position. This allows the distance between the turning elements, which are in the first position and in the second position and are adjacent to each other, to be increased, thereby increasing the space available for turning medical containers. The different arrangement of the contact elements on the turning element means that adjacent turning elements can be assigned different control cams, which can increase the space available for turning the medical containers, as adjacent turning elements can be shifted differently.

Optionally, the first control cam is designed so that two adjacent turning elements are arranged at different positions between the first position and the second position. In other words, this ensures that adjacent turning elements are not in the same position when moving between the first position and the second position. This safely prevents collisions.

Optionally, the second control cam is designed so that two adjacent holding elements are arranged at different rotational positions between the first rotational position and the second rotational position. Analogous to the above, this ensures that adjacent turning elements, to which medical containers are attached, do not turn or rotate at the same time, thus preventing collisions between the medical containers.

Optionally, the holding element is designed to turn the medical container in the second position. In other words, when the turning element is in the second position, the holding element can turn or rotate the medical container. This means that in a situation where sufficient space is available, the medical container held by a holding element can be turned. The turning can be carried out without contact with or interference from adjacent elements or other medical containers.

Optionally, the holding element is designed to hold a medical container by means of negative pressure. This allows for particularly gentle handling of the medical containers. In particular, the transfer of the medical containers to the turning starwheel can be simplified, as the turning starwheel can easily pick up and then hold the medical container by applying negative pressure. Furthermore, the vacuum can be adjusted to suck or hold different medical containers or different weights of medical containers, so that a variety of medical containers can be transported.

Optionally, double suction cups can be used. This offers the advantage that standard components can be used. In particular, for taller containers, it is possible to attach two suction cups in order to double the holding force and achieve more favorable distances to the center of gravity of the respective container.

Optionally, the holding element is designed to rotationally shift (displace) a medical container held on the holding element between a first rotational position and a second rotational position. In other words, a rotating container, for example, with an opening facing upwards, can be fed to the turning starwheel, rotated by the turning starwheel by essentially 180° so that the bottom of the medical container faces upwards, and then released from the turning starwheel. The first rotational position can represent the starwheeling position. The second rotational position can represent the target position to which the medical container is to be moved. While the medical container is held by the holding element, it can be shifted from the first rotational position to the second rotational position. This shift can be continuous or sequential. The shift between the first rotational position and the second rotational position can take place as long as the turning element rotates together with the base element around the first axis. This allows a spatial shift of the medical container and an orientation of the medical container to be changed simultaneously. This allows efficient handling of the medical container to be provided.

Optionally, rotation between the first rotational position and the second rotational position of the medical container is a rotation of substantially 180°. Since it is often important when handling medical containers to change the orientation of the medical container so that the bottom of the medical container points upwards in the gravity direction, it is advantageous that the turning starwheel can rotate the medical container by 180°. This makes it possible to subsequently inspect the medical container in a beneficial manner.

Optionally, the second axis runs orthogonally to the first axis. The second axis can be the axis around which the medical container is turned or rotated between the first rotational position and the second rotational position. The first axis can be the axis around which the base element rotates. The fact that the second axis runs orthogonally to the first axis allows an easily controllable overall system to be created, which can be operated advantageously.

Optionally, the holding element is designed to shift the medical container held by the holding element between the first rotational position and the second rotational position during a shift of the turning element from the first position to the second position. In other words, the medical container can already be shifted between the first rotational position and the second rotational position of the turning element during the shift between the first rotational position and the second rotational position. Because the medical container is already turned during the shift of the turning element away from the base element, the turning process can be completed more quickly. Since the space required for turning the medical container is still relatively small at the beginning of the shift between the first and second rotational positions, turning can already begin when the turning element and an adjacent turning element are still arranged next to each other. Only halfway through the turning process (i.e., at approximately 90°) is the space requirement at its maximum, so it is only at this point that it must be ensured that the turning element is in the second position. This further accelerates the process and reduces cycle times. In other words, the capacity of the overall system can be increased.

Optionally, the holding element is designed to shift the medical container held on the holding element between the first rotational position and the second rotational position in the second position of the turning element. However, in the case of a particularly tight arrangement or particularly large medical containers, it is still advantageous to starwheel shifting the medical container only in the second position. In other words, a shift of the medical container between the first rotational position and the second rotational position can only begin when the turning element is in the second position. This ensures that particularly large or specially shaped medical containers do not come into contact with other elements.

Optionally, the holding element is designed to rotate the container held on the holding element about a second axis, depending on the second control cam. This allows the orientation of the medical container to be changed by rotating the medical container about the second axis. The second axis can be rotated orthogonally to the first axis about which the base element rotates.

Optionally, the holding element is designed to convert a translational movement into a rotational movement between the first rotational position and the second rotational position. More specifically, the second contact element can receive a translational movement as a control command, wherein the holding element can convert this translational movement into a rotational movement in order to move the medical container from the first rotational position to the second rotational position. The translational movement can take place along the second axis. This enables simple control of the rotation of the medical container by means of a control cam (e.g., the second control cam).

Optionally, the translational movement is initiated by the second contact element depending on the second control cam. In other words, the second contact element can be deflected by the second control cam in such a way that a translational movement is input into the turning element and converted into a rotational movement by the turning element.

Optionally, the holding element has a holding area that is designed to hold the medical container and come into direct contact with the medical container. The holding area can be an end effector of the turning element. The holding area can be the area that directly contacts the medical container.

Optionally, the holding area is designed as a suction cup. This allows inaccuracies during transfer to be compensated for by an elastic suction cup. This allows the medical container to be handled particularly gently.

The holding element has a vacuum feedthrough to hold the medical container at the holding area of the holding element. The vacuum feedthrough runs along the second axis. The vacuum feedthrough can ensure that a vacuum can be applied to the holding area, even though the holding area can be shifted between the first rotational position and the second rotational position. This enables a continuous supply of negative pressure to the holding element or holding area.

Optionally, the holding element comprises a lever mechanism that connects the second contact element to the holding area. This allows the translational movement introduced into the holding element by the second contact element to be amplified, so that a relatively small deflection of the second contact element is sufficient to generate a relatively larger translational movement. This allows the movements of the second contact element to be kept small, while still applying sufficient control movement to the turning element to initiate the rotation of the medical container between the first rotational position and the second rotational position.

Optionally, the second contact element can actuate a spindle nut. Actuating the spindle nut can cause an associated spindle to rotate. This rotation can shift the holding range between the first rotational position and the second rotational position in a rotary manner. The spindle nut can be actuated by the second contact element directly or via a lever mechanism. This allows the translational movement to be reliably converted into a rotational movement. The spindle can therefore also be referred to as a linear drive. The feed rate v_{f} gives the speed of the spindle depending on the thread pitch. In other words, the desired value can be calculated using the equation v_{f} = n*P. Here, n is the speed of the spindle shaft and P is the thread pitch. In this case, the thread pitch is optionally 40 mm to 50 mm with a diameter of 10 mm. It has been found that the best results are achieved when the medical container is rotated 180° with minimal wear.

Optionally, the spindle nut can be operated vertically from above. It has been found that gravity-assisted operation can reduce wear on the entire system.

Optionally, the turning element has an actuating element, at one end of which the second contact element is arranged, and at the other end of which the spindle nut is provided. Optionally, the second contact element and the spindle nut are rigidly connected to each other. In other words, a deflection of the second contact element can be directly translated into a translational movement of the spindle nut. The spindle nut can then in turn actuate the spindle in a rotary manner. Thus, the actuating element can optionally be shifted between a first actuating element position and a second actuating element position. The first actuating element position is realized when the medical container, which is held by the holding element, is in the first rotational position. Similarly, the actuating element is returned to the second actuating element position when the medical container held by the holding element is in the second rotational position. Optionally, the actuating element has a locking mechanism that is designed to fix the actuating element in the first actuating element position. Furthermore, the locking element can be designed to fix the actuating element in the second actuating element position. Fixing can mean that the actuating element is held in the respective position in such a way that it does not leave this position on its own. In other words, the actuating element can only be shifted from the first actuating element position and/or from the second actuating element position if an external force is applied to the actuating element. A shift between the first actuating element position (i.e., from the first rotational position) to the second actuating element position (i.e., to the second rotational position) can be initiated, for example, by the second control cam via the second contact element. Once the actuating element has reached the second actuating element position, it does not return to the first actuating element position by itself. This allows the medical container to remain in the second rotational position once it has been reached. This is important because when the medical container is turned at the turning starwheel, it is not desirable for the medical container to be turned back immediately after turning. Rather, it is desirable for the medical container to be discharged from the turning starwheel in the turned position. The initiation of a movement of the holding element from the second holding element position back to the first holding element position can be effected, for example, by the second contact element. Furthermore, a further actuating element may also be provided, which actively or passively returns the actuating element from the second actuating element position to the first actuating element position. For example, this may be a stop which is contacted when the base element rotates about the first axis. Optionally, the actuating element is shifted back to the first actuating element position in a situation where no medical container is held on the holding element. In other words, the medical container can be fed to the turning starwheel at an input position, then turned by a further shift of the turning starwheel about the first axis and discharged at a discharge position. If the turning starwheel moves between the discharge position and the input position, the actuating element can be shifted between the second actuating position and the first actuating position. This shifts the old area back to the first rotational position so that a new medical container can be picked up to be turned.

Optionally, the holding element comprises a lever mechanism or a drive mechanism that connects the second contact element to the holding element. In other words, the second contact element can be indirectly connected to the holding element. The lever mechanism allows a control command entered to the second contact element to be adjusted to cause a corresponding movement of the holding element. This allows the overall system to be designed more compactly. The drive mechanism allows a control command entered into the turning element to be transmitted to the holding element. This allows direct control of the holding element by the control cam.

According to a further aspect of the present disclosure, a method for turning medical containers is provided. The method may comprise holding a medical container on a holding element of a turning element. Furthermore, the method may comprise moving the turning element from a first position to a second position. In addition, the method may comprise turning the medical container held by the holding element from a first rotational position to a second rotational position when the turning element moves from the first position to the second position or is in the second position. The method may comprise moving the turning element from the second position to the first position.

This provides a method for turning a medical container, in which the turning elements can be provided close to each other. The space required for turning the medical container can be provided by the shift between the first position and the second position of the turning element.

According to a further aspect of the present disclosure, a use of the above turning starwheel for turning medical containers is provided.

Embodiments and individual features of the above disclosure can be combined with each other to form new embodiments. Advantages and configurations mentioned in connection with the embodiments or features also apply analogously to the new embodiments. Configurations and advantages mentioned in connection with the device also apply analogously to the method and vice versa.

### BRIEF DESCRIPTION OF THE DRAWINGS

The present disclosure is described in detail below with reference to the accompanying figures.

FIG. 1 shows a schematic and perspective view of a turning starwheel according to an embodiment of the present disclosure;

FIG. 2 shows a schematic top view of a turning starwheel according to an embodiment of the present disclosure;

FIG. 3 shows a schematic top view of a turning starwheel according to one embodiment of the present disclosure;

FIG. 4 shows a schematic and perspective view of a turning starwheel according to one embodiment of the present disclosure;

FIG. 5 shows a schematic side view of a turning starwheel according to one embodiment of the present disclosure;

FIG. 6 shows a schematic partial view of a turning starwheel according to one embodiment of the present disclosure;

FIG. 7 shows a schematic view of a turning element according to one embodiment of the present disclosure;

FIG. 8 shows a schematic sectional view of a turning element according to one embodiment of the present disclosure;

FIG. 9 shows a schematic and perspective view of a turning element according to one embodiment of the present disclosure;

FIG. 10 shows a schematic sectional view of a turning element according to one embodiment of the present disclosure; and

FIG. 11 shows a schematic flow chart of a method according to an embodiment of the present disclosure.

### DETAILED DESCRIPTION OF THE PREFERRED EMBODIMENTS

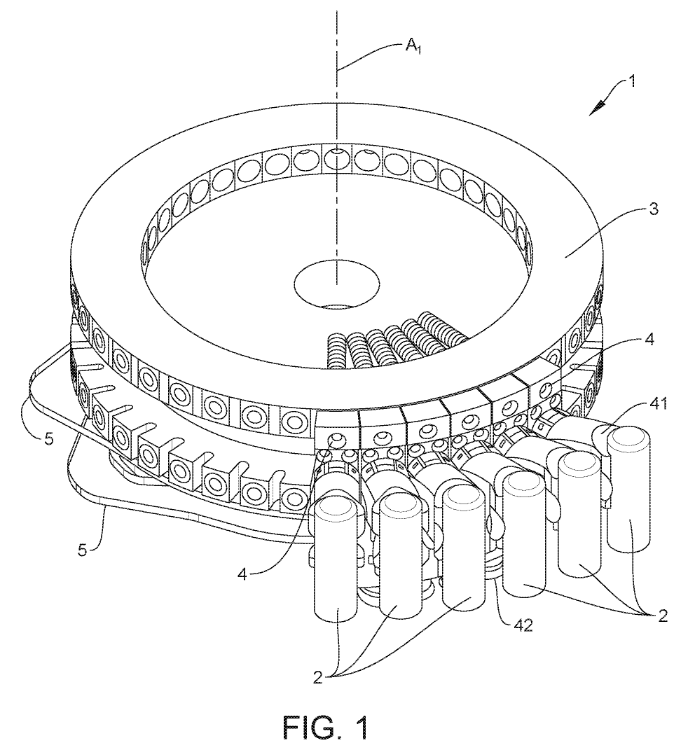

FIG. 1 shows schematically and in perspective a turning starwheel 1 according to an embodiment of the present disclosure. In the present embodiment, the turning starwheel 1 has a substantially circular base element 3. The base element 3 is designed to be rotatable about a first axis A1. A plurality of turning elements 4 are arranged adjacent to one another on the outer circumference of the base element, which is designed as a cylinder. In FIG. 1, only 6 turning elements 4 are shown, but the entire outer circumference of the base element 3 may be provided with turning elements 4. Each turning element 4 has a holding element 41 to which a medical container 2 can be attached. In the embodiment shown in FIG. 1, a medical container 2 is attached to each of the six turning elements 4 shown. In the gravity direction, which runs parallel to the first axis A1, several control cams 5, 6 are arranged below the base element 3. More precisely, two first control cams 5 are provided, which are in contact with a first contact element 42 provided on each of the turning elements 4. The contact can be continuous or intermittent. In any case, the first control cam 5 can contact the first contact element 42 to transmit a control command to the turning element 4.

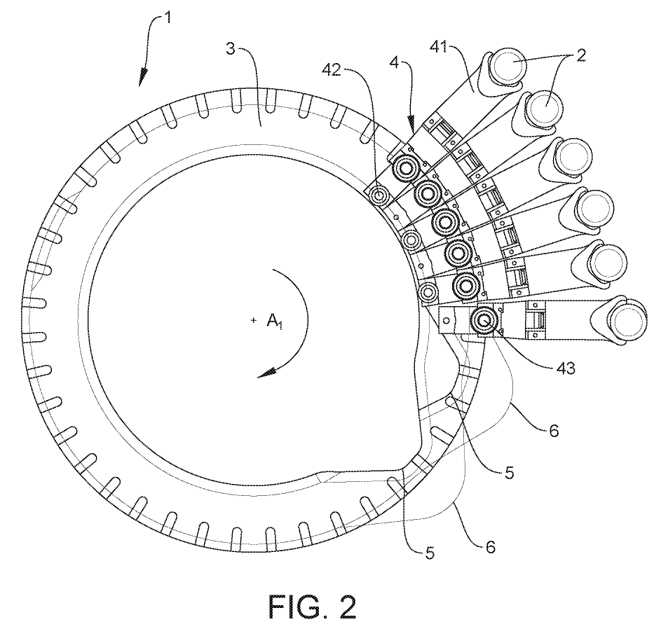

FIG. 2 is a schematic top view of the turning starwheel 1 from FIG. 1. In contrast to FIG. 1, the base element 3 in FIG. 2 is further rotated around the first axis A1 (see arrow in FIG. 2). The top view shows that each turning element 4 has a first contact element 42 and a second contact element 43. The first contact element 42 is in contact with the first control cam 5, whereas the second contact element 43 is in contact with the second control cam 6. Each contact element can only be in contact with one control cam. In the present embodiment, two first control cams and two second control cams are provided, each offset from the other. The control cams 5, 6 can thus transmit control signals to the first contact element 42 and the second contact element 43. The first contact element 42 can receive the control command so that the turning element 4 moves radially outward away from the base element 3. The second contact element 43 can receive the control command so that the holding element 41, which holds the medical container 2, rotates in such a way that the medical container is turned.

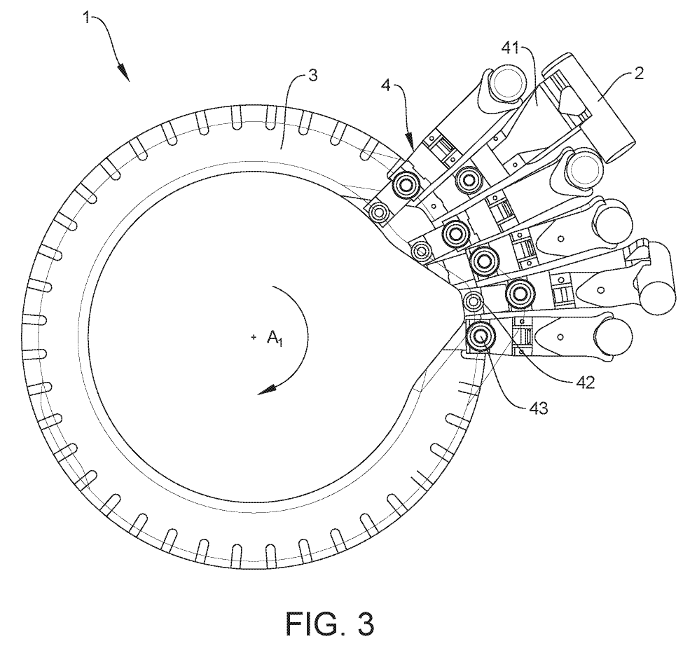

FIG. 3 is a schematic top view of the turning starwheel 1 shown in FIG. 2, with the difference that the base element 3 has been rotated further in the direction of the arrow. Now, the first control cams 5 and the second control cams 6 are in contact with the first contact elements 42 and the second contact elements 43 of the six turning elements 4 shown in such a way that some turning elements 4 have moved away from the base element 3 (control command entered via the first contact element 42) and some of the medical containers 2 are turned (control command entered via the second contact element 43). The continuous movement of the base element 3 relative to the existing control cams 5, 6 enables simple control, ensuring seamless and smooth turning of the medical containers 2. It can be seen that the radial outward movement of the turning elements 4 alone creates the space required to turn the medical container. In the configuration shown in FIG. 2, it would not be possible to turn the medical containers because the medical containers 2 would come into contact with adjacent turning elements 4 or adjacent medical containers 2.

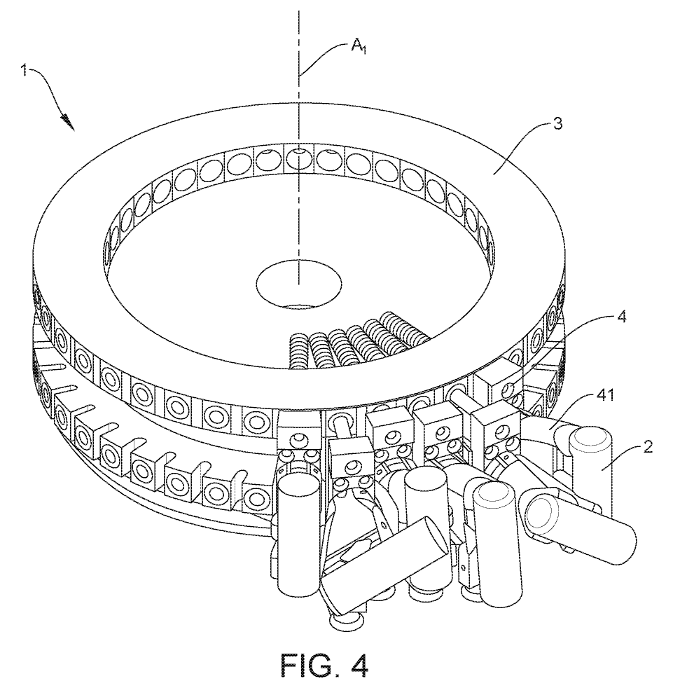

FIG. 4 is a schematic and perspective view of a turning starwheel 1 according to the embodiment shown in the previous figures. It can be seen that adjacent turning elements 4 are positioned in different positions relative to adjacent turning elements. Furthermore, holding elements 41 of the respective turning elements 4 are rotated so that the available space is optimally used to turn the medical container 2 held by a holding element 41. The scenario shown in FIG. 4 is merely an example, and any coordinated movement patterns are possible as long as sufficient space is created to turn the respective medical container 2. This configuration can be achieved by arranging and designing the control cams 5, 6. In the present embodiment, the medical containers 2 are rotated by essentially 180° in order to enable inspection of the bottom area.

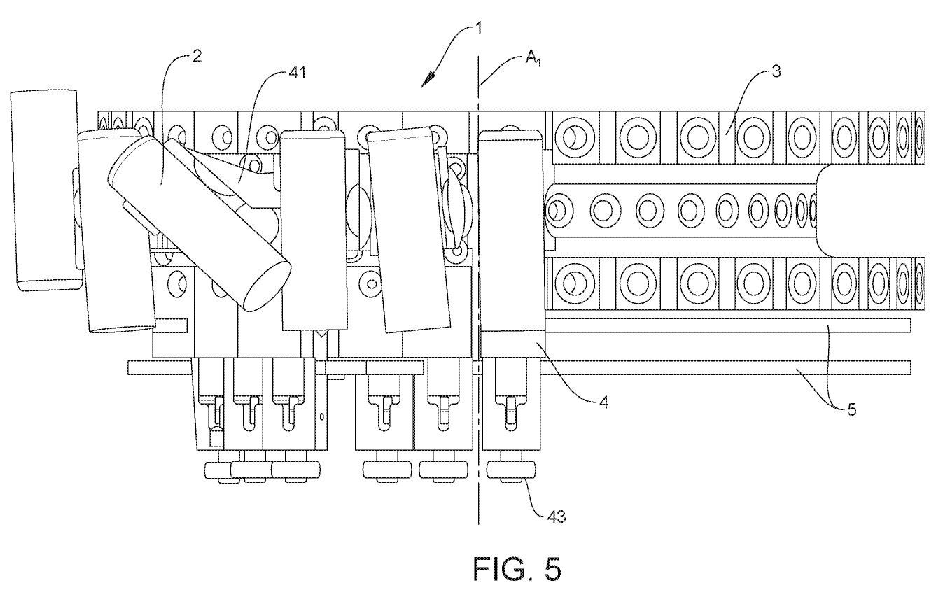

FIG. 5 is a schematic side view of a turning starwheel 1 according to the embodiments shown in the previous figures. FIG. 5 shows how the control cams 5, 6 are provided. Only the first two control cams 5 are shown in FIG. 5. The first control cams 5 are in contact with the first contact element 42 (not visible in FIG. 5). The second control cams 6 (not shown in FIG. 5) are spaced apart from the first control cams and can come into contact with the second contact element 43 of each turning element 4. In other words, the first contact element 42 and the second contact element 43 can be arranged at different height positions in the gravity direction. This makes it easy to define which control cam the respective contact element should come into contact with. It is also conceivable that the contact elements 42, 43 are detachably attached to a turning element so that they can be easily repositioned or removed in order to define which control cam the respective contact element should come into contact with. This allows the turning starwheel to be easily customized.

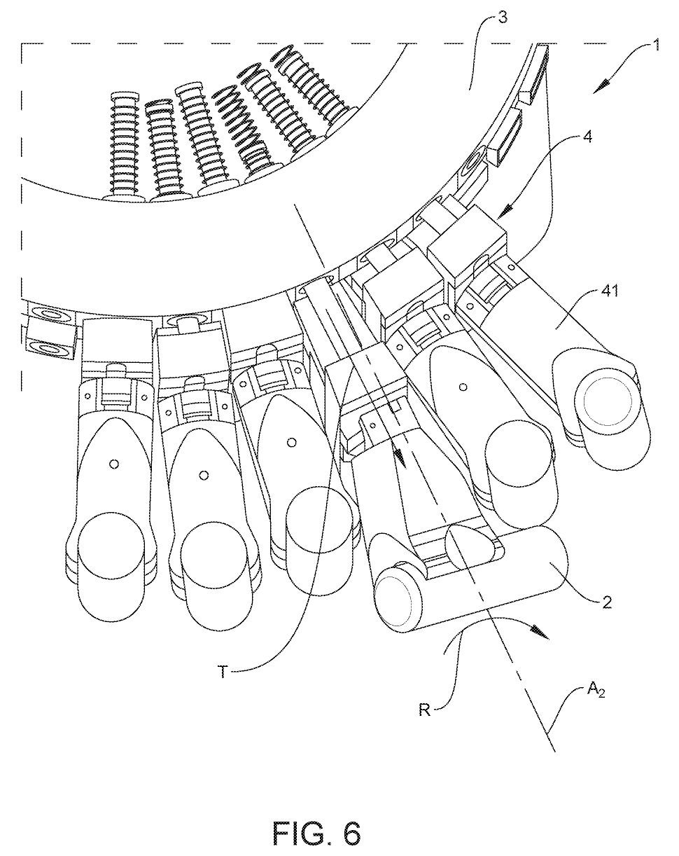

FIG. 6 is a schematic and perspective partial view of a turning starwheel 1 as shown in the previous figures. FIG. 6 shows the two different movements, namely the translational movement T, which moves the turning element away from the base element 3 (in the present embodiment radially outward), and the rotational movement R, which turns the medical container 2 about a second axis A2. The second axis A2 is orthogonal to the first axis A1.

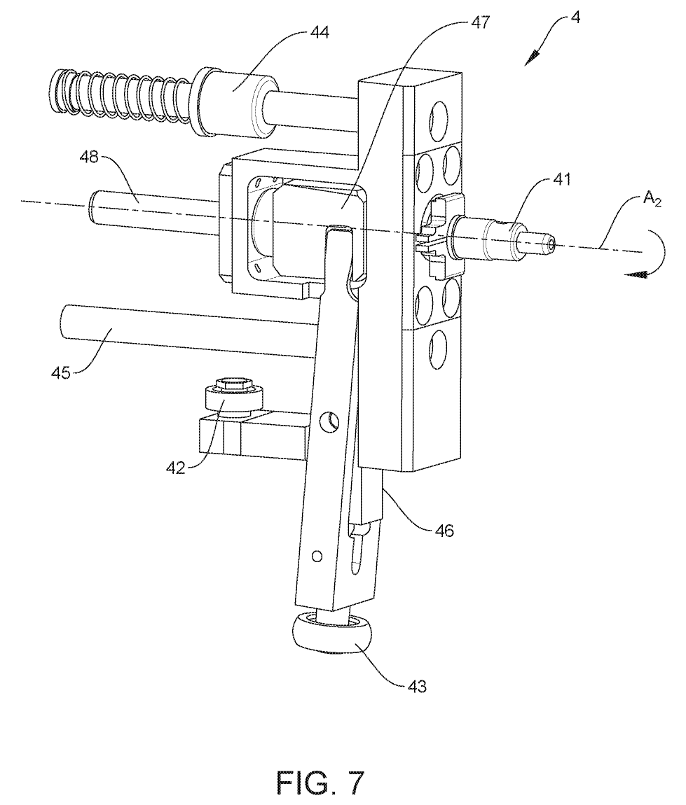

FIG. 7 is a schematic perspective view of a turning element 4 according to an embodiment of the present disclosure. As already described above, the turning element 4 has a first contact element 42 and a second contact element 43. Both contact elements 42, 43 are designed as roller elements in order to minimize wear when in contact with the control cams 5, 6. The first contact element 42 is designed to shift between the first position (as shown in FIG. 1 for the turning elements) and a second position (as shown in part for the contact elements in FIG. 3). The second contact element 43, on the other hand, is designed to turn a holding element about the second axis A2. In this process, the second contact element 43 is deflected, thereby actuating a lever mechanism 46, which in turn shifts a spindle nut 47, causing a spindle 48 to rotate. The rotation of the spindle 48 around the second axis (see arrow in FIG. 7) then triggers the turning of the medical container 2 fixed to the holding mechanism (not fully shown in FIG. 7).

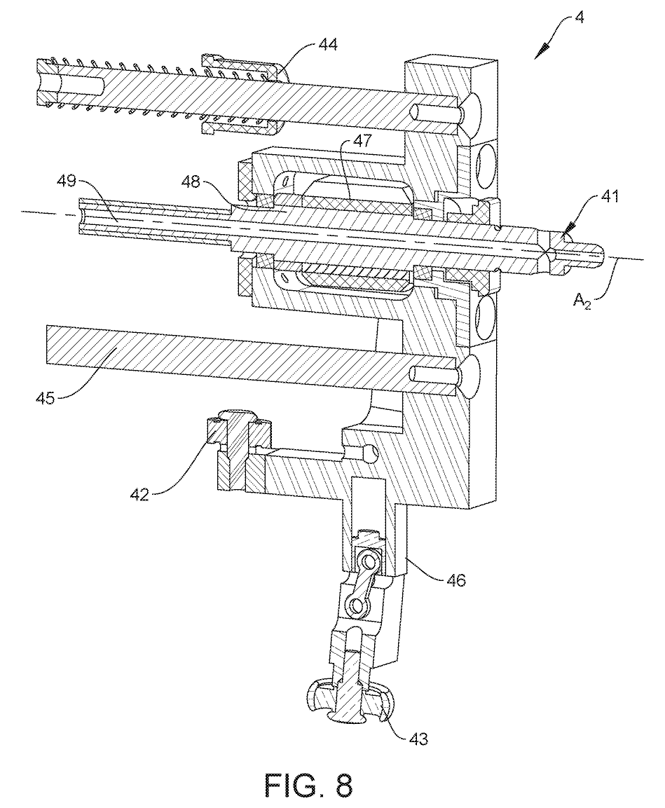

FIG. 8 is a schematic and perspective sectional view of the turning element 4 from FIG. 7. In addition to FIG. 7, FIG. 8 shows the vacuum feedthrough 49, which is designed to transport a negative pressure to the holding element 41. This allows the negative pressure to be transported through the turning element 4 (i.e., from a fixed body to a rotating body) to the holding element 41, even though the holding element can rotate around the second axis A2. Furthermore, the lever mechanism for actuating the spindle nut 47 is shown in detail. There is a guide piston that guides the shift. This prevents tilting or unwanted shifting and thus detachment of the second contact element 43 from the second control cam 6.

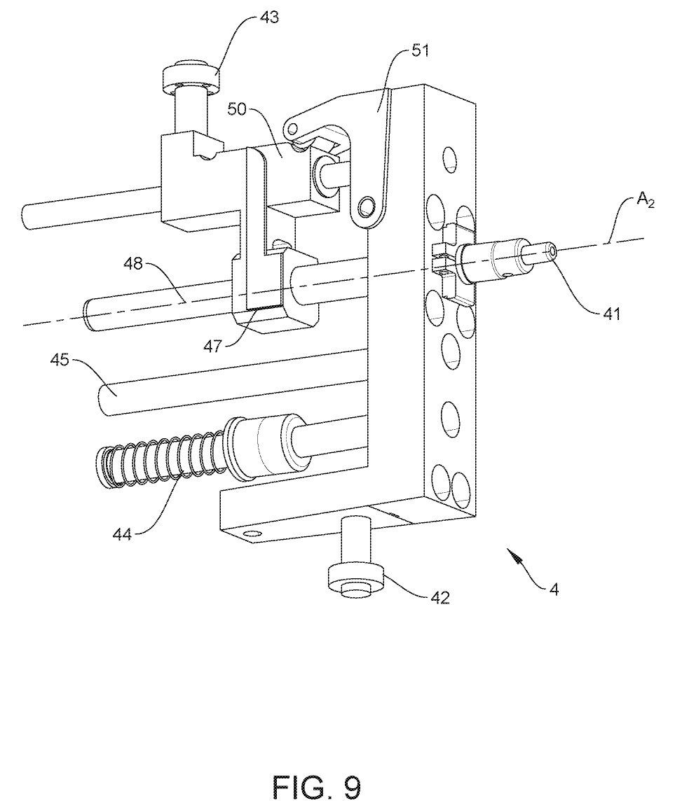

FIG. 9 is a schematic and perspective view of a turning element 4 according to another embodiment of the present disclosure. In the present embodiment, the first contact element 42 is arranged above (in the gravity direction) the turning element 4. The second contact element 43 is still provided at a lower end of the turning element 4. In this embodiment, the spindle nut 47 is not actuated by a lever mechanism, but by a linear drive mechanism or shift mechanism 50. In other words, the second contact element 43 is deflected by the second control cam 6, causing the second contact element 43 to shift in a translational manner. This also causes the shift mechanism 50 to shift in a translational manner, thereby also shifting the spindle nut 7. The shift of the spindle nut 47 causes the spindle to rotate and rotates the holding element 41 (not fully shown in FIG. 9) about the second axis A2. FIG. 9 also shows a locking mechanism 51 that is capable of fixing the shift mechanism 50 in the first position or the second position. For this purpose, the locking mechanism 51 has two recesses, each of which is arranged at one end of the transmission unit 50. In the first position, the locking element is arranged in the first recess so that unintentional shifting is prevented. When the second contact element 43 is then actuated by the second control cam 6, the locking element 51 is shifted into the other recess and remains there again. In other words, the locking element is now positioned so that the medical container is held in the second rotational position. The locking mechanism 51 allows the medical container 2 to be held in the second rotational position until it is released from the turning starwheel 1. By shifting the locking mechanism back to the first rotational position, the respective turning element 4 can be made ready again to receive a new medical container. This actuation to return to the first rotational position can in turn be achieved by shifting the second contact element 43. For example, a contact element may be provided which returns the second contact element to the first rotational position.

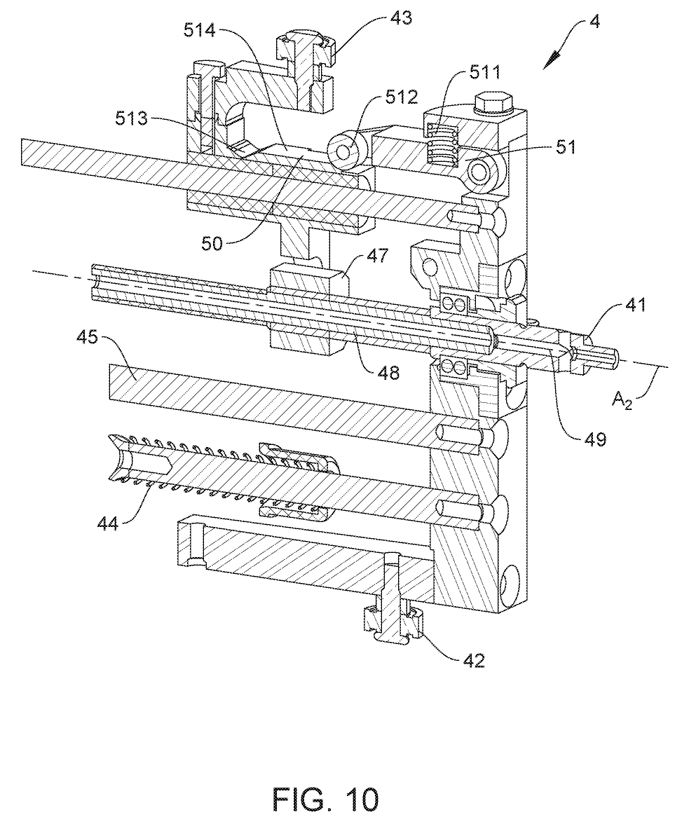

FIG. 10 is a schematic and perspective sectional view of the turning element 4 from FIG. 9. FIG. 10 shows the vacuum feedthrough 49, which is designed to guide a vacuum along the axis A2. Furthermore, the locking element 51 is shown in detail. The locking element 51 has a clamping element 511 (designed as a spring in this embodiment). The clamping element is designed so that a sliding element 512 of the locking element 51 rests on a contact surface 514 and, in particular, is pressed against it. This ensures contact between the sliding element 512 and the contact surface 514. In the present embodiment, the sliding element 514 is designed as a roller. The contact surface 514 has a first recess 513 and a second recess 515 into which the sliding element 512 can engage. This allows the sliding element 512 to be fixed in two different positions by positive locking. One position corresponds to the first rotational position, whereas the other position corresponds to the second rotational position. This allows the respective rotational position to be defined and secured against unintentional shift.

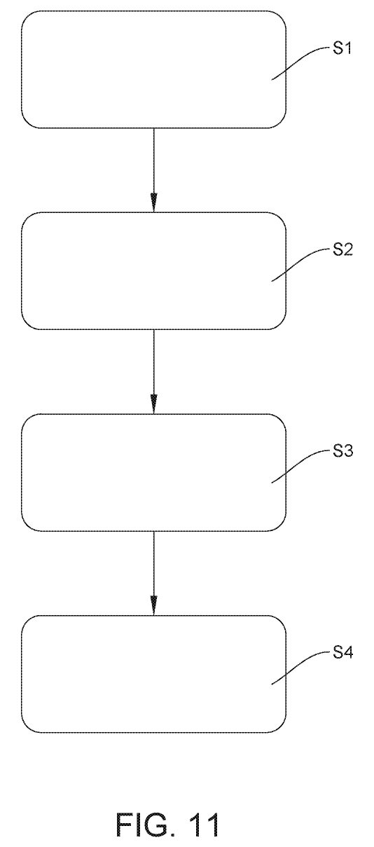

FIG. 11 is a schematic flow chart that schematically depicts the sequence of a method for turning medical containers. First, in step S1, a medical container 2 is held on a holding element 4 of a turning element 1. Then, in step S2, the turning element 4 is transferred from a first position to a second position. In other words, the turning element 4 can be removed from a base element of the turning starwheel. Subsequently, in step S3, the medical container 2 held by a holding element 41 is transferred from a first rotational position to a second rotational position when the turning element 4 moves from the first position to the second position or is arranged in the second position. This allows the medical container to be turned when there is sufficient space to do so. In step S4, the turning element 4 is returned from the second position to the first position. This allows the turning element, together with the medical container held on it, to be transferred to a position where the medical container can be easily released from the turning starwheel 1. Optionally, as long as the medical container 2 is held on the turning element 4, the second rotational position is maintained without it falling back into the first rotational position. This ensures that the medical container is released in a turned position.

### LIST OF REFERENCE SIGNS

1 Turning star

2 Medical container

3 Base element

4 Turning element

5 First control cam

6 Second control cam

41 Holding element

42 First contact element

43 Second contact element

47 Spindle nut

48 Spindle

49 Vacuum feedthrough

50 Shift mechanism

51 Locking mechanism

A2 Second axis

A1 first axis

1. A turning starwheel for turning medical containers, comprising:
a base element on which a plurality of turning elements is provided, wherein each turning element comprises:
a holding element configured to hold and turn a medical container; and
a first contact element configured to come into contact with a first control cam;
wherein the turning element is configured to shift between a first position and a second position relative to the base element depending on the first control cam.

2. The turning starwheel according to claim 1, wherein the turning elements are detachably held on the base element.

3. The turning starwheel according to claim 2, wherein the shift of the turning element occurs relative to the base element.

4. The turning starwheel according to claim 3, wherein the first control cam differs from the second control cam in terms of arrangement and/or shape.

5. The turning starwheel according to claim 4, wherein the holding element is configured to rotationally shift a medical container held on the holding element between a first rotational position and a second rotational position.

6. The turning starwheel according to claim 5, wherein the holding element is configured to shift the medical container held on the holding element between the first rotational position and the second rotational position during shifting of the turning element from the first position to the second position.

7. The turning starwheel according to claim 5, wherein the holding element is configured to shift the medical container held on the holding element between the first rotational position and the second rotational position in the second position of the turning element.

8. The turning starwheel according to claim 5, wherein the holding element is configured to rotate the container held on the holding element about a second axis depending on the second control cam.

9. The turning starwheel according to claim 8, wherein the holding element is configured to convert a translational movement into a rotational movement between the first rotational position and the second rotational position.

10. The turning starwheel according to claim 9, wherein the translational movement is converted into a rotational movement between the first rotational position and the second rotational position of the holding element via a spindle nut and a spindle.

11. The turning starwheel according to claim 10, wherein the holding element comprises a lever mechanism or a drive mechanism connecting the second contact element to the holding element.

12. The turning starwheel according to claim 1, wherein the shift of the turning element occurs relative to the base element.

13. The turning starwheel according to claim 1, wherein the first control cam differs from the second control cam in terms of arrangement and/or shape.

14. The turning starwheel according to claim 1, wherein the holding element is configured to rotationally shift a medical container held on the holding element between a first rotational position and a second rotational position.

15. The turning starwheel according to claim 1, wherein the holding element is configured to shift the medical container held on the holding element between the first rotational position and the second rotational position during shifting of the turning element from the first position to the second position.

16. The turning starwheel according to claim 1, wherein the holding element is configured to shift the medical container held on the holding element between the first rotational position and the second rotational position in the second position of the turning element.

17. The turning starwheel according to claim 1, wherein the holding element is configured to rotate the container held on the holding element about a second axis depending on the second control cam.

18. The turning starwheel according to claim 1, wherein the holding element is configured to convert a translational movement into a rotational movement between the first rotational position and the second rotational position.

19. The turning starwheel according to claim 1, wherein the translational movement is converted into a rotational movement between the first rotational position and the second rotational position of the holding element via a spindle nut and a spindle.

20. A method for turning medical containers, comprising:
holding a medical container on a holding element of a turning element;
moving the turning element from a first position to a second position;
turning the medical container held by the holding element from a first rotational position to a second rotational position when the turning element moves from the first position to the second position or is in the second position, and
moving the turning element from the second position to the first position.
